(19) United States
(12) Patent Application Publication
(10) Pub. No.: US 2004/0208002 A1
(43) Pub. Date: Oct. 21, 2004

(54) Endurable decoration light string

(76) Inventor: Jeng-Shyong Wu, Hsin-Chu City (TW)

Correspondence Address: McGlew and Tuttle, P.C., Scarborough Station, Scarborough, NY, 10510-0827, US

(21) Appl. No.: 10/694,673

(22) Filed: Oct. 28, 2003

(30) Foreign Application Priority Data
Apr. 18, 2003 (CN) 03 2 38468.8

(51) Int. Cl. H01R 33/00

(52) U.S. Cl. 362/226; 362/249

(57) ABSTRACT

The present invention relates to an endurable decoration light string, which composed of light strings and one or more non-electrical connector. The light string includes mutually connective luminaries and electrical connector, in which the luminaries are composed of luminescent elements including lamp bulb, tungsten lamp, LED and lamp holder. Electrical conductor can be single or multiple wires, and its characteristic is to use non-electrical connector parallel or winding to fix on the predetermined fixed position of both head and tail ends and center part of the decoration light string. To tie a knot on the predetermined fixed position to enhance endurable strengthen of decoration light string. Thus, during the arrangement, the draw force of the decoration light string will be firstly supported by non-electrical connector to avoid the damage on the decoration light string whereby to increase life time on decoration light string.

### BACKGROUND OF THE INVENTION

The present invention relates to an endurable decoration light string, especially it relates to a kind of design to enforce the endurance of decoration light string. While using, the present invention is able to provide decoration light string on both head and tail ends and central parts not to get loose whereby to make sure the stabilization of transmission power as well as increase life time on the new design of decoration light string.

Decoration light strings are commonly used in the soirée and celebration occasions. The great joyous feeling or atmosphere can rely on various decoration light strings to embellish the conference hall. Commonly known decoration light string no matter single or multiple wires in traditional style to arrange the conference hall or by using latest network lighting style to arrange the hall, they all have some parts being not contacted well in many decoration light strings, especially commonly having seen on both head and tail ends. The main reason of such formation is not careful to pull and drag during installing the light string. Even through this will not affect the whole decoration light string to start. However, the vision result will be affected more or less so that it is unfortunately beautiful and incomplete.

### SUMMARY OF THE INVENTION

The purpose of the present invention is to provide an endurable decoration light string, and said light string is fixed on the predetermined fixed position of both head and tail ends and central parts. The appropriate equipment can be installed to resist the draw force so as to increase the life time of decoration light string.

A further purpose of present invention is to provide an endurable decoration light string by means of non-electrical connector so that the draw force of the decoration light string will be firstly supported by non-electrical connector to avoid the damage on the decoration light string whereby to increase life time on decoration light string. Further, the strength of the draw force of the non-electrical connector is greater than that of single or multiple electrical conductors and the rate of extension is small than that of electrical conductor.

The present invention of the endurable decoration light string is including: luminaries and electrical conductor, winding with parallel, series or series and parallel connection. The characteristic is to use non-electrical connector parallel or winding to fix on the predetermined fixed position of both head and tail ends and center part of the decoration light string. To tie a knot on the predetermined fixed position to enhance endurable strengthen of decoration light string. Further, the winding of the decoration light string and the non-electrical connector is able to use non-electrical connector as an axis to wind the decoration light string.

According to the characteristic mentioned above, the strength of draw force of non-electrical connector is greater than one or more electrical connector. Further, the predetermined fixed position can be on the long trunk or separate area in the position of electrical conductor of on luminaries. However, the non-electrical connector can be composed of single wire, multiple wires or several connectors. When the non-electrical connector is composed of multiple wires and winding with several decoration light strings, the non-electrical connector and every decoration light string are to form round, triangle, rhombus, and square shape or predetermined pictures or words to make the luminaries on the electrical conductor becoming similar body shape surrounding.

Further, in the present invention of endurable decoration light string, another characteristic is that when multiple electrical conductors separate out to connect with luminaries, the multiple electrical conductors on one side of long trunk can be a curve. Therefore, after to tie a knot firmly with non-electrical connector, a buffering function is obtained. The electrical conductor will not be affected if the draw force is formed and the non-electrical connector will take the force.

### BRIEF DESCRIPTION OF THE DRAWINGS

FIGS. 1 and 2 are perspective views showing the example of non-electrical connector to tie a knot on electrical conductor and luminaries in endurable decoration light string of the present invention.

FIGS. 3 and 4 are perspective views showing the example on the network shape of the single and twin wires non-electrical connector to tie the knots respectively in decoration light string of the present invention.

FIG. 5 is a perspective view showing the example on ring shape of the single and twin wires of the non-electrical connector to tie the knots respectively in decoration light string of the present invention.

FIG. 6 is a perspective view showing the example of on non-electrical connector attached leaf shape of decorating article in the endurable decoration light string of the present invention.

### DETAILED DESCRIPTION OF THE PREFERRED EMBODIMENTS

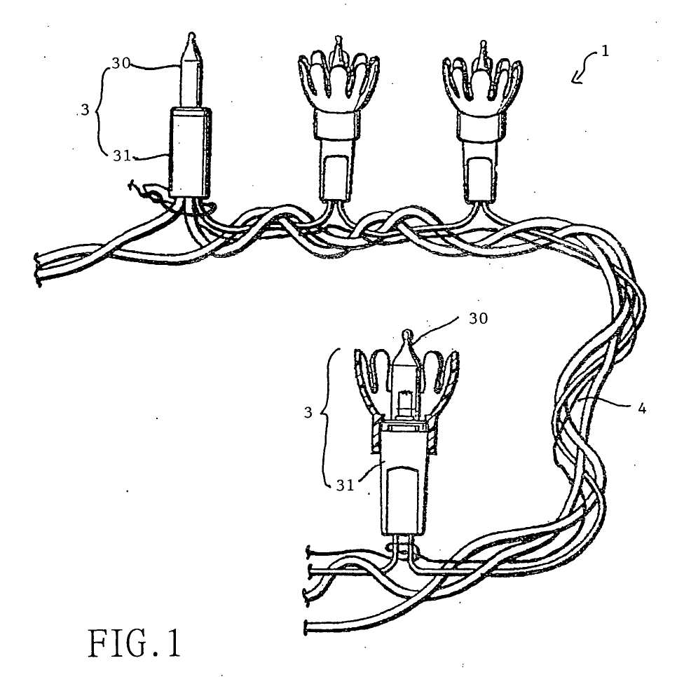

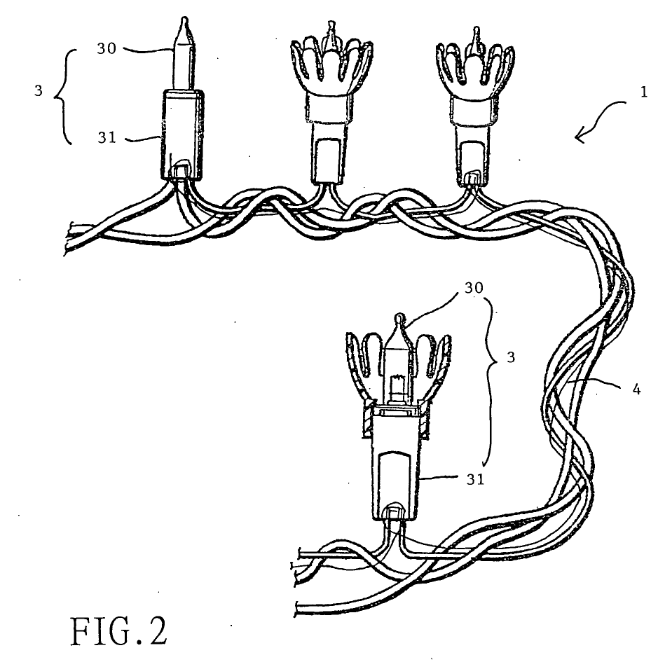

Now referring to FIG. 1, an endurable decoration light string 1 of the present invention includes: electrical conductor 2, luminary 3 and non-electrical connector 4, in which, the electrical conductor 2 is predetermined length. In this drawing, it is only to take a small section for description. Each of luminaries 3 connected on electrical conductor 2 is composed of lamp bulb 30 and lamp holder 31. Further, along with electrical conductor 2, the non-electrical connector 4 is parallel and winding with it, also fixing a knot on the long trunk of said electrical conductor 2. Thus the strength of draw force of decoration light string 1 can be enhanced. Similar, FIG. 2 (also taken small section of decoration light string 1) is showing that one non-electrical connector 4 is used in parallel winding, and make a knot on luminary 3 so that the strength of draw force of decoration light string 1 can be enhanced.

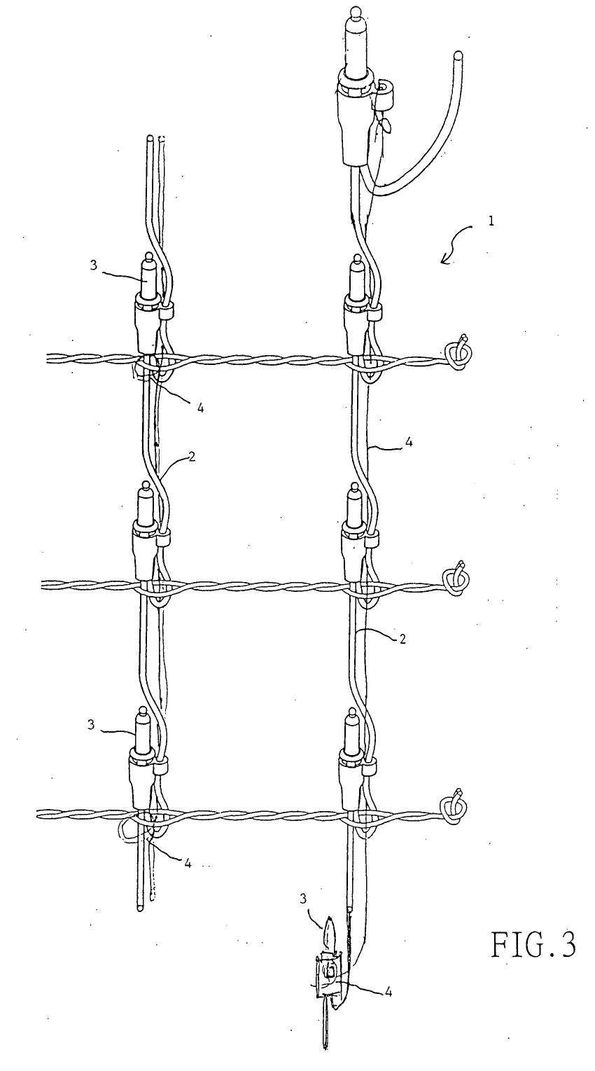

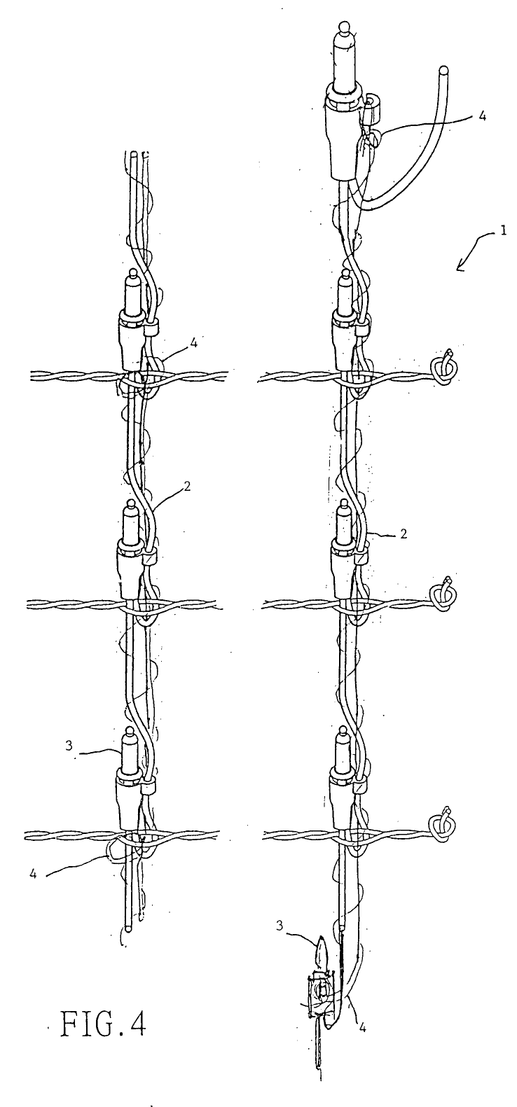

Also, referring FIG. 3, it is the network shape of the decoration light string 1. For the convenience of understanding, it is to take a small section for description. It is composed of many electrical conductors 2, luminaries 3 and non-electrical connector 4 by means of parallel series interconnect into one unit. Further, every electrical conductor 2 locates on aside of the long trunk becoming a curve shape to have buffering function after taking a knot firmly with non-electrical connector 4. However, on few predetermined fixed position, non-electrical connector 4 is used to wind and take a knot. The left side on the drawing is fixing a knot on electrical conductor 2 of long trunk, and then the right side is fixing a knot on luminary 3. Therefore, when it has the draw force and the non-electrical connector 4 is able to support it, such draw force will not affect to the electrical conductor 2. Similarly, FIG. 4 is network shape of decoration light string 1, in which two non-electrical connectors 4 to use to tie a knot with electrical conductor 2 of long trunk.

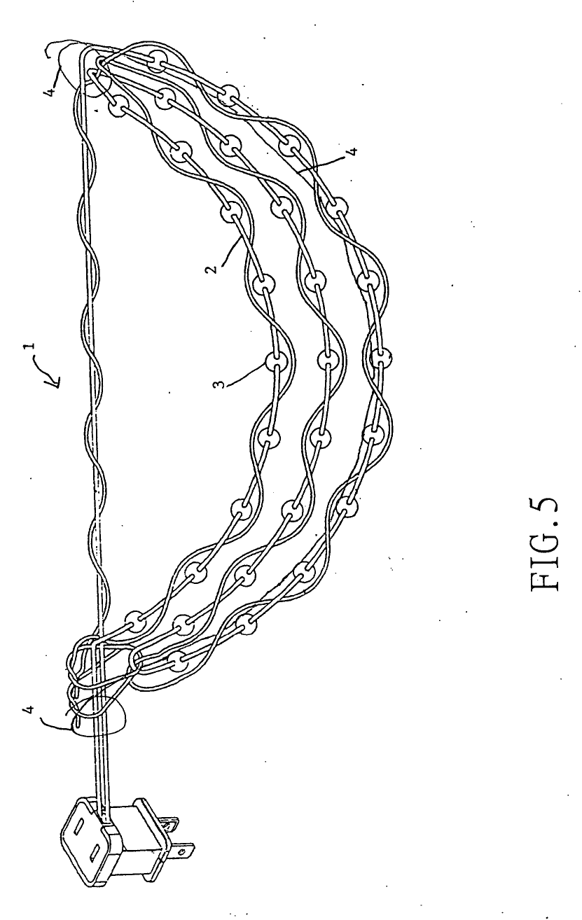

FIG. 5 is a kind of ring shape of decoration light string 1. Above said ring shape of light string, it is composed of many electrical conductor 2, luminaries 3 and non-electrical connector 4 by means of series to interconnect into one unit. Using non-electrical connector 4 to wind with electrical conductor 2, the knots are taken on both head and tail ends of electrical conductor 2. Therefore, when the draw force is occurred, the non-electrical connector 4 is able to support it, and such draw force will not affect to the electrical conductor 2.

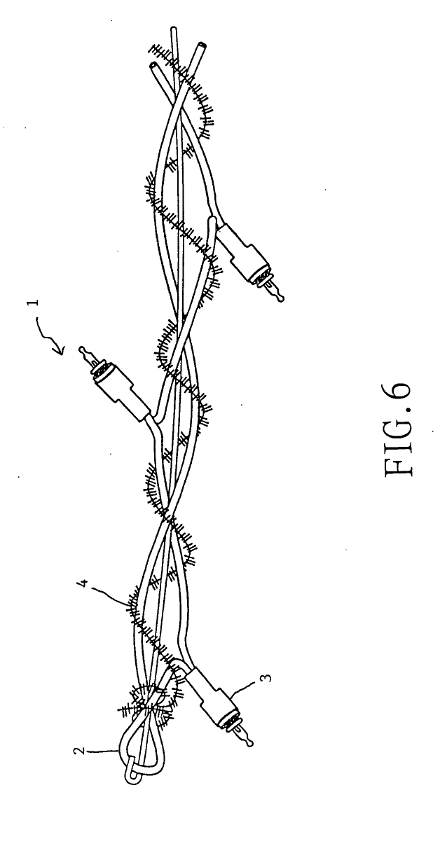

Referring to FIG. 6, it is similar with endurable decoration light string 1 in FIG. 1 only to attach leaf shape of decorating articles on non-electrical connector 4. This can enhance the beauty of decoration light string. Also, one end is showing a long trunk to become a curve shape on electrical conductor 2. Therefore, it has a buffering function when the non-electrical conductor 4 is knotted.

The features and preferred embodiments of the present invention have been described in the foregoing specification. The invention intended to be protected herein, however, is not to be construed as limited to the particular forms disclosed. Variations and changes, which maybe made by those skilled in the art, are with out departing form the scope of the present invention.

### SYMBOL LISTS

1 endurable decoration light string

2 electrical conductor

3 luminary

4 non-electrical connector

30 lamp bulb

31 lamp holder

What is claimed is:

1. An endurable decoration light string, composing of light strings and one or more non-electrical connector, the light string including mutually connective luminaries and electrical connector, said electrical conductor being single or multiple wires, and its characteristic being to use non-electrical connector parallel or winding to fix on the predetermined fixed position of both head and tail ends and center part of the decoration light string, to tie a knot on the predetermined fixed position to enhance endurable strengthen of decoration light string.

2. An endurable decoration light string as claimed in claim 1, wherein the strength of the draw force of the non-electrical connector being greater than that of single or multiple electrical conductors and the rate of extension being smaller than that of electrical conductor.

3. An endurable decoration light string as claimed in claim 1, wherein the electrical conductor being longer than the non-electrical connector in between two or more than two predetermined fixed positions.

4. An endurable decoration light string as claimed in claim 1, wherein the non-electrical connector being parallel and winding with the electrical conductor to the predetermined fixed positions.

5. An endurable decoration light string as claimed in claim 1, wherein the predetermined fixed position being on the long trunk or separate area in the position of electrical conductor or on luminaries.

6. An endurable decoration light string as claimed in claim 1, wherein the winding of the decoration light string and the non-electrical connector being able to use non-electrical connector as an axis to wind the decoration light string.

7. An endurable decoration light string as claimed in claim 1, wherein the multiple electrical conductors to be separated out to connect with luminaries, the multiple electrical conductors on one side of long trunk being a curve, after to tie a knot firmly with non-electrical connector, a buffering function being obtained, the electrical conductor being not affected while the draw force being formed and the non-electrical connector being able to take the force.

8. An endurable decoration light string as claimed in claim 1, wherein the non-electrical connector composed of single wire, multiple wires or several connectors.

9. An endurable decoration light string as claimed in claim 1, wherein the non-electrical connector being to attach decorative articles, such as leaf or designed pattern.

10. An endurable decoration light string as claimed in claim 1, wherein the non-electrical connector composed of multiple wires and winding with several decoration light strings, the non-electrical connector and every decoration light string to form round, triangle, rhombus, and square shape or predetermined pictures or words to make the luminaries on the electrical conductor becoming similar body shape surrounding.

11. An endurable decoration light string as claimed in claim 1, wherein the luminaries and the electrical conductor being connected series, parallel or series parallel inter-connection together.

12. An endurable decoration light string as claimed in claim 1, wherein the luminaries being composed of luminary components such as: lamp bulb, tungsten lamp, LED and lamp holder or lamp base.

13. An endurable decoration light string, composing of light strings and one or more non-electrical connector, the light string including mutually connective luminaries and electrical connector, said electrical conductor being single or multiple wires, and its characteristic being to use non-electrical connector parallel or winding to fix on the predetermined fixed position of both head and tail ends and center part of the decoration light string, to tie a knot on the predetermined fixed position firmly, during the draw force being done, and before the damage or loss being done on the connection area of the electrical conductor and the luminaries, the draw force being supported by non-electrical connector to keep and to enhance endurable strengthen of decoration light string.

14. An endurable decoration light string, composing of light strings and one or more non-electrical connector, the light string including mutually connective luminaries and electrical connector, said electrical conductor being single or multiple wires, and its characteristic being to use non-electrical connector parallel or winding to fix on the predetermined fixed position of both head and tail ends and center part of the decoration light string, to tie a knot on the predetermined fixed position firmly, the length of decoration light string be longer than non-electrical connector, during the draw force being done, said draw force being supported by non-electrical connector to protect the endurable strengthen of decoration light string.

15. An endurable decoration light string, composing of light strings and one or more non-electrical connector, the light string including mutually connective luminaries and electrical connector, said electrical conductor being single or multiple wires, and its characteristic being to use non-electrical connector parallel or winding to fix on the predetermined fixed position of both head and tail ends and center part of the decoration light string, to tie a knot on the predetermined fixed position firmly, the decoration light string and non-electrical connector being parallel or winding along the electrical conductor to fix on the predetermined fixed position.
